(19) United States
(12) Patent Application Publication
(10) Pub. No.: US 2003/0051610 A1
(43) Pub. Date: Mar. 20, 2003

(54) Adapter, device and method for sampling from a multichamber bag, use of said adapter and bag packaging

(76) Inventors: Roland Dux, Spreitenbach Ag (CH); Peter W Merz, Wollerau (CH); Stephan Oderbolz, Morristown, NJ (US)

Correspondence Address: BURNS DOANE SWECKER & MATHIS L L P, POST OFFICE BOX 1404, ALEXANDRIA, VA, 22313-1404, US

(21) Appl. No.: 10/149,988

(22) PCT Filed: Dec. 5, 2000
(86) PCT No.: PCT/IB00/01798

(30) Foreign Application Priority Data
Dec. 17, 1999 (CH) 2315/.99

(51) Int. Cl. A23N 1/00

(52) U.S. Cl. 99/495

(57) ABSTRACT

The present invention relates to an adapter (1), an apparatus for and a method of extracting commodities from the pack compartments (28a, 28b) of a multicompartment sausage pack (10) in which the commodities extracted from the compartments (28a, 28b) are led in the adapter (1) separately in separate through flow channels (11a, 11b). By means of this the commodities can be extracted from the compartments of the multicompartment sausage pack in set proportional amounts without a forced intermixing.

### CROSS REFERENCES TO RELATED APPLICATIONS

This application claims the priority of the Swiss Patent Application No. 1999 2315/99 which was filed on Dec. 17, 1999 and of which the entire disclosure is herewith incorporated by reference.

### TECHNICAL FIELD

The present invention relates to an adapter, an apparatus for and a method of extracting commodities from multicompartment sausage packs, a sausage pack packaging and an application of the adapter in accordance with the introductory portions of the independent claims.

### PRIOR ART

Sausage pack packagings are conventionally put in to use advantageously in all such cases in which liquid up to pasty commodities are to be packed in small amounts and with a minimum of packing material. The extracting proceeds after a willful destruction of the outer skin of the sausage pack packaging.

The advantages of this packing technology have led to the situation that nowadays also the components of multicomponent systems, specifically of multicomponent adhesive agent systems are filled into sausage pack packagings and namely preferably in such a manner that upon the mixing of the individual components packed in relative proportional quantities in a packaging the correct mixing proportion is arrived at.

In this context systems are known in which two single compartment sausage packs with the components of a two component adhesive agent system are interconnected by a connecting part which serves simultaneously as extraction adapter and leads the components together. As an example the system Hilti HIT HY-150 shall be mentioned here, as well as the adapters disclosed in the documents EP 0 665 063 A1 and BE 1 008 472 A3, which are foreseen for the extraction of components from several single compartment sausage packs. All these systems have the drawback that the amounts of the commodities, which are proportional relative to each other, are, since they are packed in individual single compartment sausage packs, not undetachably connected to each other and/or the packagings have unfavorable dimensions and that for the operation there is the need of special extraction apparatuses with separate pressing out cylinders for each pack of which additionally the pressing out pistons must be synchronized relative to each other. Such extraction apparatuses are generally expensive to procure, heavy and cumbersome.

U.S. Pat. No. 3,323,682 discloses two embodiments of a one way cartridge packaging with several compartments, e.g. for the components of two component adhesive agent systems, which includes in its interior two foldable receptacles forming the compartments for the components. This cartridge does indeed contain the individual components in the desired proportional amounts and in a undetachable state and can be additionally processed in conventional manual presses, but it causes, however, a multiple amount of the packaging garbage of sausage pack packagings of the same contents.

EP 0 754 633 A2 discloses multicompartment sausage pack packagings in which the components of a two component adhesive agent, contrary to the designs mentioned above, are placed in a compact manner and undetachably in separate compartments inside a multicompartment sausage pack. For the processing, an end formed by the compartments of the multicompartment sausage pack of same is pulled through a central discharge opening of an extraction apparatus and opened thereafter, so that the components fed out of the compartments of the multicompartment sausage pack flow into each other at the exit of these compartments. A at least initially separate extracting of the components or the producing of a commodity flow with a certain geometry of distribution of the extracted components, e.g. for the feeding of same to a following static mixer, is not possible in this manner.

### SUMMARY OF THE INVENTION

Thus, there is the object to provide apparatuses for and methods of extracting commodities from multicompartment sausage packs and sausage pack packagings, as well, which do not feature the previously mentioned drawbacks.

This object is met by the adapter, the apparatus for and the method of extracting commodities out of multicompartment sausage packs, as well as by the sausage pack packaging according to the independent claims.

In one aspect of the invention, the adapter is designed for an extracting of commodities from multicompartment sausage packs, especially from double compartment sausage packs, and specifically so that the components extracted from the compartments are guided separately in the adapter. To this end the adapter comprises at least two through flow channels for the feeding of the commodities contained in the pack compartments through same and is designed in such a manner that the inner walls of the through flow channels come to contact directly the commodities which are contained in the pack compartments. This leads to the advantage that a controlled extracting of the commodities present in the individual compartments without a forced mixing of same, as well as a non-mixed provision at different, precisely defined positions at the adapter for possible subsequent systems or elements such a feeding lines, delivering nozzles and/or mixing elements is made possible. Especially at certain static mixing elements a geometrically precise infeeding of the components to be mixed is often of a large importance for the result of the mixing. Several mechanisms can be foreseen regarding the feeding of the components out of the pack compartments, the feeding may proceed due to gravitational force, due to air pressure at aspiration and by a production at a positive pressure in the pack compartments, as well. A simple possibility for producing a positive pressure consists in a manual pressing of the pack or to subject same to a pressure by means of a simple pressing out device such as e.g. a conventional manual press for sealing agent cartridges.

The commodities extracted from the compartments are guided in the adapter preferably in a substantially axial direction in relation to the axis of the multicompartment sausage pack to be coupled to the adapter and brought to be discharged in an axial direction.

The discharge openings of the through flow channels are located preferably at the side of the adapter facing away from the multicompartment sausage pack, so that an exiting of the components extracted from the sausage pack compartments can proceed at this side substantially in an axial direction relative to the axis of the sausage pack. It is, furthermore, of advantage when the discharge openings are additionally located substantially in a central area of the adapter. Especially in case of applications in which discharging nozzles following the adapter are enlisted, such leads to a slim arrangement with a substantially axial extent wherewith an application of the commodity to be discharged is simplified also at constricted space situations.

The adapter includes preferably means for an opening of the sausage pack compartments wherewith a purposive opening due to a piercing or cutting of the outer skin of the sausage pack is ensured. In a preferred embodiment these means are firmly arranged in the adapter and are preferably designed in such a manner that an opening of the pack compartments of the sausage pack to the through flow channels of the adapter occurs at the first purposive acting by pressure onto the sausage pack equipped with the adapter or by the setting on and pressing on of the adapter onto the sausage pack. In a other embodiment these means for an opening are arranged moveably in the adapter and specifically preferably in such a manner that they can be brought from the outside into the adapter. To this end for instance needle or dagger shaped piercing or cutting, resp. tools or such having other shapes are suitable. Specifically preferred are embodiments in which a substantially simultaneous opening of at least two pack compartments to at least two through flow channels can he ensured. This proceeds advantageously by a mechanical coupling of moveable opening devices. Specifically in the case of an application in connection with multicomponent adhesive agent systems and mixing elements which follow the adapter it is of utmost importance that beginning with the first instance all components are made available in the correct mixing proportions, because only a precisely defined mix of the components leads to the desired adhesive agent properties.

If devices for a further processing of the extracted commodities are to be arranged subsequent to the adapter it is advantageous when the adapter includes coupling devices for a coupling to elements or apparatus structures which follow the adapter, specifically mixing devices and/or nozzles. These coupling devices include advantageously screw structures, but also all other known coupling methods can be foreseen such as e.g. bayonet connections, snap connections, force locked plug-on connections or adhesive agent bondings. The coupling devices can, furthermore, include further functional elements such as e.g. seals.

In a still further preferred embodiment of the invention the adapter is designed in such a manner that at least two components are led together in the adapter in the area of its exit, and specifically that these components are mixed in this area.

The adapter is produced preferably of a plastic material with a low adhesive force relative to the multicomponent adhesive agents. This leads to the advantage that a mechanical removing of the cured adhesive agent remnants at the exit of the adapter is simplified. It is also preferred to have the adapter produced by an injection molding because in case of large quantities the production costs become therewith to be especially low.

In a further aspect of the invention an arrangement for extracting commodities from sausage packs includes an adapter as described previously and at least one means for leading the components extracted from the bag chambers together. These means can be for instance discharging nozzles or mixing elements, specifically static mixing elements.

In a preferred embodiment the arrangement includes, furthermore, a pressing out device for the multicompartment sausage pack. In this respect all devices can be thought of which are in the position to produce a positive pressure in the compartments of the sausage pack, such as e.g. axially acting cylinder presses with a pressing punch and a receiving tube, radially pressing devices or also receptacles which are acted upon by a pressure into which the sausage pack can be inserted.

In still another aspect of the invention a sausage pack packaging includes an adapter or a device as described above as well as a multicompartment sausage pack, specifically a double compartment sausage pack. This sausage pack can be firmly mounted to the adapter, e.g. by a glueing or a welding. This has among others the advantage that a manual placing of the adapter onto the sausage pack is done away with, the adapter is mounted undetachable to the bag and a possible incorrect positioning of the pack compartments relative to the through flow channels by the user is excluded. In this way also the sealing between adapter and outer skin of the sausage pack and thus also the sealing between the through flow channels can be ensured.

In a preferred embodiment the through flow channels in the adapter communicate in the unopened state of the sausage packaging with the pack compartments, i.e. the pack compartments are open towards the through flow channels and the discharge openings of the through flow channels are closed.

This is effected advantageously by closing means whereby it is preferred that the closing means are reclosable and specifically that they include screw type closures so that at an interruption of the extracting or an exchange of the product the partly emptied sausage pack packaging can be closed again for a temporary storage. It is especially desirable that the reclosable closure means are mounted undetachably to the adapter.

It is also preferred to have the discharge openings of the through flow channels of the adapter closed off by one or several removable or rupturable foils, specifically metal foils which can be peeled off. Also combinations of foils and reclosable closing means can be thought of, such as e.g. of a metal foil for a sealing of the discharge openings of the not used packaging and screw type closure for a closing of the packaging after it has been partially used.

In a further aspect of the invention the previously described adapter is used for a filling of multicompartment sausage packs, specifically double compartment sausage packs.

A final aspect of the invention refers to a method of extracting commodities from multicompartment sausage packs, in particular of extracting commodities from double compartment sausage packs, whereby the commodities which have been withdrawn from the pack compartments are led in an adapter by at least two through flow channels located in the adapter substantially separate from each other through the adapter and are brought thereby into a direct contact with the inner walls of the through flow channels.

### BRIEF DESCRIPTION OF THE DRAWINGS

Further preferred embodiments of the invention follow from the dependent claims and the now following description, as well, with reference to the drawings, wherein

FIG. 1 is a sectional view of an adapter in accordance with the invention with two through flow channels;

FIG. 2 is a top view of the adapter of FIG. 1 seen from the inlet side;

FIG. 3 is a sectional view of the adapter of FIG. 1 with means for opening the sausage pack compartments which are firmly mounted in the adapter;

FIG. 4 is a sectional view of the adapter of FIG. 1 with means for opening the sausage pack compartments which are brought in from the outside;

FIG. 5 illustrates a multicompartment packaging followed by a static mixing element in a pressing out apparatus;

FIG. 6a is a sectional view of a double compartment sausage pack with two pack compartments arranged side by side;

FIG. 6b is a sectional view of a double compartment sausage pack with pack compartments of differing sizes arranged side by side;

FIG. 6c is a sectional view of a double compartment sausage pack with pack compartments of differing sizes arranged inside of one another;

FIG. 6d is a sectional view of a further double compartment sausage pack with pack compartments of differing sizes arranged inside of one another;

FIG. 6e is a sectional view of a double compartment with pack compartments of an equal size arranged in an outer sausage jacket common to both.

### MODES FOR CARRYING OUT THE INVENTION

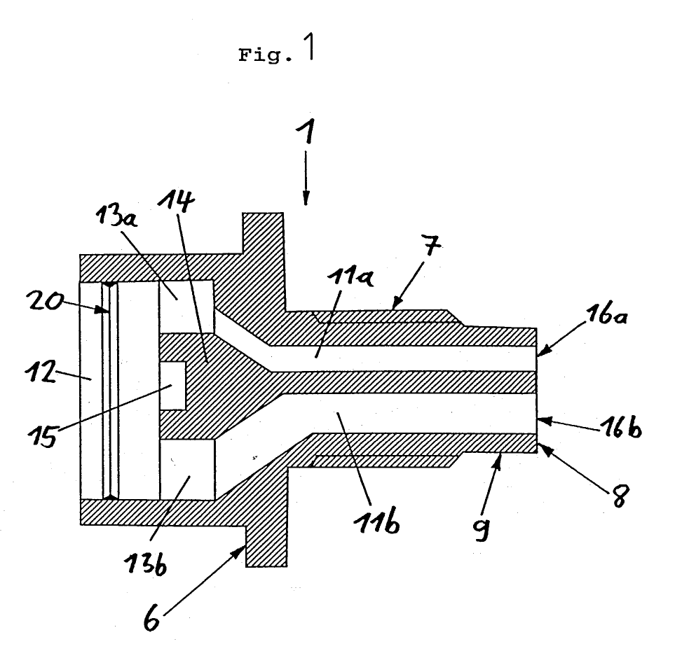

A preferred embodiment of the invention is illustrated in FIG. 1. As can be seen in this sectional view, the adapter 1 includes two through flow channels 11 and 11b which are separated from each other, which extend axially through same and are foreseen for the separate. transport of the commodities which are contained in the compartments of a double compartment sausage pack. As can be seen, the illustrated adapter includes at the inlet side a flange like structure which forms an axial shoulder 6. This shoulder can serve as an axial abutment surface when mounting the adapter 1 in front of the cylinder of a pressing out device by means of an axial pressing on device such as e.g. a cap screw with a thread or a bayonet type locking structure. The adapter 1 includes at the outlet side an outer thread structure 7 as mounting means for subsequent elements such as e.g. mixer and/or discharge nozzles. Additionally, the free end of the thread structure is designed here in such a manner that it forms a stub at the outlet side of the adapter 1 which provides for axial 8 and also radial sealing surfaces 9.

As can be seen, furthermore, the adapter 1 includes at the inlet side a rim 12 which can serve at the one hand for a centering if a pressing out device is used and at the other hand encloses the end of the sausage pack and stabilizes this end radially when the sausage pack is open. This rim serves also the purpose of sealing the opened end against the outside. Depending from the viscosity of the commodities to be processed, this sealing can be due to the radial pressing on force ensuing from a pressure action and/or for instance by a glueing or a welding. Certain sealing elements such as e.g. radial circumferentially extending rigid or elastic sealing edges or grooves 20 can also be brought into use, wherewith the sealing action is improved.

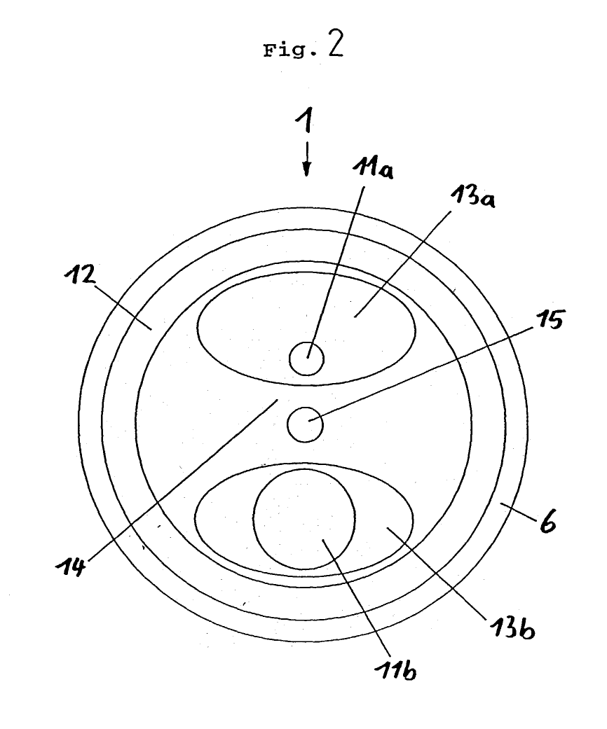

Such as can be seen in FIG. 2, the space enclosed by the rim 12 opens into the recesses 13a and 13b which in turn open into the through flow channels ha and 11b. The recesses 13a and 13b are separated from each other by a web 14, which includes at its center a further recess 15 for the receipt of a closing clip of a sausage pack packaging. The recess 15 ensures that the outer skin of the sausage pack can abut the web 14 and accordingly the recesses 13a and 13b are sealed against each other. Also here, the sealing is, depending from the viscosity of the commodities to be processed, due to the axial pressing on force ensuing from a pressure action and/or by a glueing or a welding. Also here certain sealing elements such as e.g. rigid or elastic sealing edges or noses can be brought into use, wherewith the sealing action is improved. Additionally, embodiments can be thought of in which the recesses 13a, 13b are formed by the through flow channels 11a, 11b.

Such as illustrated in the FIGS. 1 and 2, the adapter 1 includes two through flow channels 11a and 11b with different cross-sections, which extend axially through same and form at the outlet side in a central area outlet openings 16a, 16b which cause an exiting of the commodities guided through the through flow channels in an axial direction. The purposive design of the cross-section of the through flow channels leads to the possibility to influence depending from the viscosities and sought proportional amounts of the commodities contained in the pack compartments at the discharging thereof the pressure losses in each through flow channel in such a manner, that upon a same positive pressure in the pack compartments, e.g. by application of a conventional manual pressing device, a discharging with substantially the same proportional amounts of the masses over the entire duration of the discharge is arrived at. Foreseen are, however, also embodiments with through flow channels 11a, 11b with cross-sections of equal size. The discharge from the outlet openings 16a and 16b in axial direction and also their arrangement in the center of the adapter 1 is specifically for such a case advantageous, in which a slim arrangement of discharging device, adapter and following elements such as e.g. discharge nozzle and/or mixing device is to be put together, because it is possible to realize therewith an arrangement with a substantially axial extent. If, however, the commodities which are contained in the pack compartments are merely to be extracted and/or forwarded separately, it can also be of advantage to place the outlet openings 16a, 16b of the adapter 1 at a larger distance between each other, and this in axial and in radial position, as well. It also can be thought of to provide the adapter 1 possibly with additional further elements such as e.g. mixing devices and/or discharge nozzles as single part or also as a sausage pack packaging with a multicompartment sausage pack. In such a case the sausage pack and the adapter 1 can be mounted firmly together by a glucing or a welding and form a inseparable unit. This has among others the advantage that a manual setting of the adapter 1 onto the sausage pack is not applicable and the adapter 1 is mounted in an undetachable manner to the sausage pack. Also, an otherwise possible manual erroneous positioning of the pack compartments to the through flow channels is prevented and the desired sealing between adapter and outer skin of the sausage pack and accordingly between the through flow channels and towards the outside is ensured.

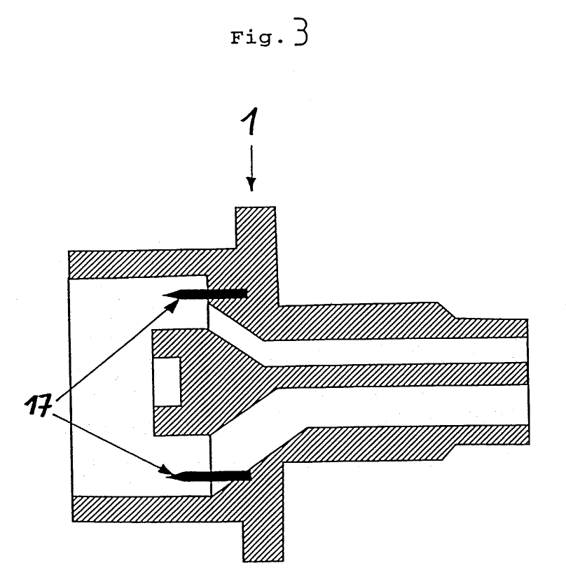

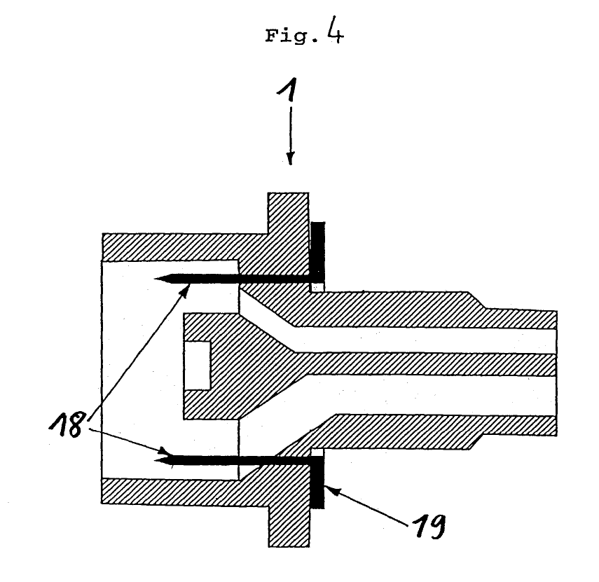

In the FIGS. 3 and 4 embodiments of the adapter according to the FIGS. 1 and 2, resp., are illustrated, which include means for opening the sausage pack compartments. The adapter 1 in FIG. 3 includes opening elements 17 which are firmly arranged in the adapter, which upon a pressing of the adapter onto a taut filled sausage pack or upon a pressing action onto the sausage pack arranged with the adapter cause a piercing or cutting of the outer skin of the sausage pack.

The adapter 1 in FIG. 4 includes piercing elements 18, which are moveable arranged inside the adapter and are brought from the outside axially into the adapter 1, wherewith a piercing of the outer skin of a sausage pack arranged with the adapter can be caused. In the here disclosed example the piercing elements 18 are mounted on a common supporting ring 19, wherewith the axial inserting of the piercing elements 18 into the adapter 1 for a piercing of the outer skin of the multicompartment sausage pack and the opening of the compartments thereof inevitably occurs at the same time. This is specifically in such a case of a large importance in which the commodities to be extracted from the pack compartments are the components of a multicomponent adhesive agent system, because in case of a with respect to time delayed openings temporary faulty bondings due to faulty mixing proportions of the components may occur. After the piercing the piercing elements 18 remain in the adapter up to a complete emptying of the sausage pack compartments in order to prevent a flowing out of commodities and/or an entering of air through the insertion openings for the piercing elements.

At the embodiments illustrated in the Figures the through flow channels are exclusively arranged in such a manner that the individual commodities exit the adapter in a not mixed state and separately in order to thereafter be transported further or then are subsequently led together and/or mixed. However, for special application likewise adapter designs can be thought of in which the commodities extracted from the pack compartments are led together and/or mixed in the area of the adapter exit. In this case, however, attention must be paid so that the zone of the leading together and mixing, respectively is easily accessible from the outside in order to allow a simple mechanical cleaning thereof. This is especially of utmost importance in such a case in which the components of curing multicomponent adhesive agents are led together or mixed.

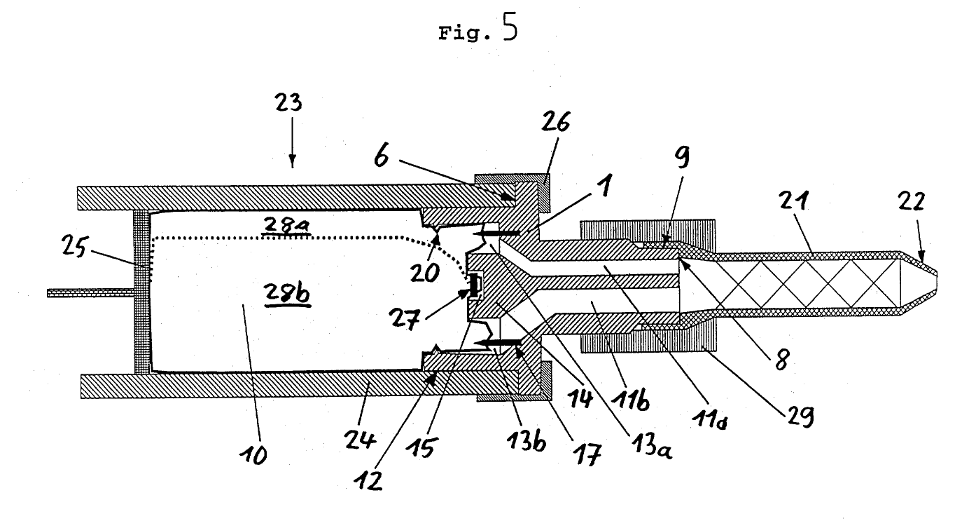

FIG. 5 illustrates a sausage pack packaging of a double compartment sausage pack 10 and an arrangement consisting of the adapter 1 according to FIG. 3 and a subsequent static mixer 21 with an integrated discharging nozzle 22 which is arranged in a pressing out apparatus 23. As clearly can be seen, the sausage pack 10 is located in the receiving tube 24 of the pressing out apparatus 23 and is subject to a pressure action by the punch 25 of the pressing out apparatus 23. The adapter 1 extends into the receiving tube 24 and is centered in same by the rim 12. The adapter 1 is pressed axially against the receiving tube 24 by a cap screw 26 and abuts same by the shoulder 6. The locking clip 27 at the end of the sausage pack 10 facing the adapter lies in the recess 15 of the partition web 14 and centers therewith the end of the sausage pack 10 in the adapter inlet. Due to the acting of pressure the sausage pack is pressed axially against the partition web 14 and radially against the radial inner surface of the edge 12 and the radial sealing recess 20 located on same and seals therewith the recesses 13a and 13b against each other and against the inner space of the receiving tube 24. At the same time the outer skin of the sausage pack is pressed into the recesses 13a and 13b and is pierced thereby by the opening elements 17 so that the communication between the two compartments 28a and 28b of the sausage pack 10 and the through flow channels 11a and 11b is established. The adapter is followed by the static mixer 21 which is set onto a stub out of which the through flow channels 11a, 11b exit the adapter and is mounted thereunto by means of a cap screw 29. The sealing between the stub and mixer and the precise positioning of same relative to each other as well, is ensured by axial 8 and radial contact surfaces 9 at the thread end section of the stub. If now, when the pack compartments are opened, the punch 25 of the pressing out apparatus 23 is further pressed in the direction of the adapter 1, a positive pressure is produced in the compartments 28a, 28b of the sausage pack which allows the commodity which is located in the pack compartment 28a to enter into the recess 13a and subsequently into the through flow channel 11a. The commodity located in the pack compartment 28b is fed into the recess 13b and subsequently into the through flow channel 11b. If the pressure action continuous further both commodities are fed separately through the through flow channels 11a and 11b and exit the adapter 1 and enter the mixer 21 at a precisely defined radial and axial position. There they will be intermixed and applied thereafter through the discharging nozzle 22 located at the mixer at the desired place. If the extracted and mixed commodities are components of a two component adhesive agent system, a prolonged interruption of the operation will lead to a curing of the adhesive agent in the mixer 21 but not in the adapter 1. In order to resume the dispensing operation it is then merely necessary to replace the mixer 21 which follows the adapter 11 and to remove possibly cured material at the exit of the adapter. Until then the old mixer can be used as closure cap for the temporary storing of the opened sausage pack packaging. In spite of the fact that in the here described example a mixer 21 with an integrated discharging nozzle 22 is described as the element which follows the adapter 1, the above given presentation can be likewise applied when only using a discharge nozzle in which the components are led together. If adapters 1 are used, in which a leading together and possibly mixing of the components happens still within their discharge area, they are designed in such a manner that possibly after the removing of a possibly following element the leading together or mixing, respectively, area is readily accessible for a mechanical cleaning. In this case, a plug formed by a cured adhesive agent can act as closure plug for the partly used sausage pack packaging until it is mechanically removed.

The combination consisting of a multicompartment sausage pack 10 and an adapter 1 with stationary opening elements 17 used in FIG. 5 is suitable for loose adapters and loose sausage packs as well as for sausage pack packagings with adapters firmly mounted to the sausage pack. It can be likewise conferred upon adapters 1 with moveable means for an opening 18 of the pack compartments 28a, 28b. It can be thought of as well to design a sausage pack packaging with a multicompartment sausage pack 10 and an adapter 1 according to FIG. 1 in such a manner that the recesses 13a, 13b and the through flow channels 11a, 11h communicate already in the not opened state of the sausage pack packaging with the pack compartments 28a, 28b and an opening of the packaging is achieved by uncovering the outlet openings 16a, 16b of the through flow channels 11a, 11b at the adapter 1. The precondition hereto is, however, that sausage pack 10 and adapter 1 are firmly mounted to each other and the spaces which communicate with the pack compartments 28a, 28b are sealed against each other and against the outside as well. This can be obtained advantageously by a glueing or a welding which is especially simple when the adapter 1 and the sausage pack 10 as well are made of the same material. The closing of the outlet openings 16a, 16b at the adapter 1 of such a sausage pack packaging can proceed in various ways. Because the adapter 1 includes advantageously mounting means 7 for the mounting of subsequent elements there is the opportunity to design the closing elements in such a manner that they make use of these mounting means 7. Specifically advantageous are for instance screw caps because they are recloseable and allow, therefore, also the closing of partly used packagings. It also can be thought of to close the outlet openings 16a, 16b off by one or several foils which can be pierced or removed for an opening. These incorporate the advantage that a partly used packaging can clearly be distinguished from a new packaging and that a hermetic sealing of the new unused packaging is ensured. It is, furthermore, possible that at a closed sausage pack packaging the through flow channels 11a, 11b end as blind holes in the stub at the exit side of the adapter 1 and are opened by a cutting off of its outermost part. Also by this means a hermetic sealing would be ensured. A specifically advantageous solution is presented, however, by a combination of reusable and destructible closing means, because by this at one hand an excellent storing capability of the commodity stored in the sausage pack packaging is ensured by a hermetic sealing and at the other hand a partly used packaging can be reclosed for the temporary storing. If, for instance, a peel off metal foil is used in combination with a screw-on cap, there is, furthermore, the advantage, that the foil is protected against a unintentional damage by the screw-on cap during the transporting and storing of the new packaging.

If the sausage pack packaging is designed in such a manner that sausage pack 10 and adapter 1 are firmly mounted to each other and the through flow channels communicate with the sausage pack compartments, it is also possible to produce not filled sausage pack packagings and to fill same thereafter or later by a connecting of a filling apparatus to the through flow channels of the adapter and to close them off thereafter at the adapter. By means of such it would be possible to produce universal packagings which can be filled by simple filling apparatuses and allow an economical packaging also in small numbers.

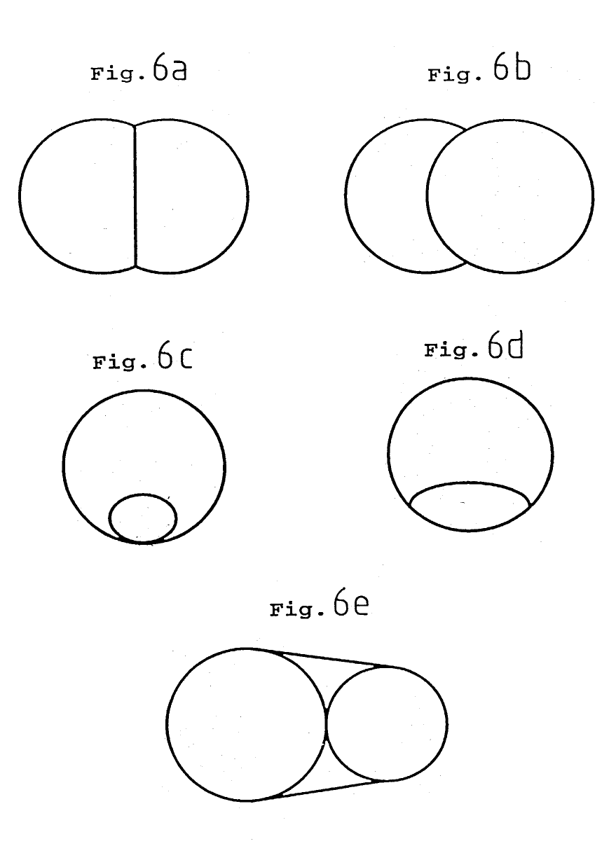

The FIGS. 6a-6e illustrate various embodiments of double compartment sausage packs which regarding their design can also be applied to sausage packs with more than two compartments. The multichamber sausage packs illustrated in the FIGS. 6a and 6b include pack compartments located side-by-side which include a common simple or double connecting wall. The sausage packs illustrated in the FIGS. 6c and 6d are designed in such a manner that the sausage pack compartment with the lesser volume is located substantially inside the chamber with the larger volume and of which the walls contact each other at least at one point. It is also possible that a part of the outer wall of the larger pack compartment forms simultaneously a part of the outer wall of the smaller pack compartment or parts of their outer walls form in common a double wall portion of the outer wall of the sausage pack. The sausage pack in FIG. 6e, however, illustrates two pack compartments with their own pack compartment walls which are interconnected bordering each other by a common sausage pack enclosure to a unit. Besides the illustrated configurations there are obviously also combinations of same possible with two or more pack compartments. It is, however, common to all multicompartment sausage packs that the pack compartments are interconnected to a unit by their adjoining walls which when subjected to a pressure action inevitably leads to a substantially uniform pressure action at all pack compartments, that all compartments of a sausage pack display substantially the same length and that at least one end of the sausage pack is closed substantially centrically, e.g. by a metal clip, which serves as common closing element for all pack compartments. The centrally closed end forms advantageously the end of the sausage pack at the adapter side. As can be seen from the examples, the amounts of the commodities filled into the multicompartment sausage pack packagings are practically not subject to limits regarding their quantity proportions wherewith they are suitable for vastly different applications. Also when on the occasion of the description of the embodiments an application for multicomponent adhesive agent system has been discussed as preferred field of application of the invention, it can be used as well for all other liquid up to pasty commodities and indeed, preferably for combinations of commodities which shall be made available in predetermined proportions of the amounts and specifically for reactive systems. Examples can be thought of such as e.g. edible stuff recipes, single component adhesive agents with curing accelerators, coatings or sealing agents.

Whereas preferred embodiments are described in the present specification if clearly shall be noted that the invention is not restricted to same and can be also embodied differently within the scope of the following claims.

1. Adapter for an extraction of commodities from a multicompartment sausage pack, specifically for an extraction of commodities from a double compartment sausage pack (10), wherein the commodities extracted from the compartments (28a, 28b) are substantially separately led in the adapter (1), characterized in that the adapter (1) comprises at least two through flow channels (11a, 11b) for the feeding of the commodities contained in the pack compartments (28a, 28b) through same and is designed in such a manner that during the extracting of the commodities contained in the pack chambers (28a, 28b)the inner walls of the through flow channels (11a, 11b) are in a direct contact with these commodities.

2. Adapter according to claim 1, characterized in that the adapter is designed in such a manner that the commodities extracted from the chambers (28a, 28b) are guided in the adapter (1) in a substantially axial direction and are brought to exit in a axial direction.

3. Adapter (1) according to one of the preceding claims for a emptying of sausage packs (10) with an axis, characterized in that the outlet openings (16a, 16b) of the through flow channels (11a, 11b) are located at the side of the adapter (1) facing away from the multicompartment sausage pack (10), so that a discharging of the commodities extracted from the pack compartments (28a, 28b) out of the adapter (1) can proceed in a substantially axial direction relative to the axis of the sausage pack (10).

4. Adapter (1) according to claim 3, characterized in that the outlet openings (16a, 16b) are located in a central area of the adapter (1).

5. Adapter according to one of the preceding claims, characterized in that the adapter (1) comprises means (17, 18) for opening the compartments (28a, 28b) of the sausage pack (10).

6. Adapter according to claim 5, characterized in that the means (17) for opening are arranged firmly in the adapter (1), and specifically in that they are designed in such a manner that an opening of the pack compartments (28a, 28b) of the adapter (1) can proceed due to a pressure action onto the sausage pack (10) or an axial pressing of the adapter (1) onto the sausage pack (10) or an axial pressing of the adapter (1) onto the sausage pack (10).

7. Adapter (1) according to claim 5, characterized in that the means (18) for opening are arranged moveably in the adapter (1), and specifically in that they can be brought from the outside into the adapter (1), and specifically that they are designed for a piercing of the outer skin of the sausage pack (10).

8. Adapter (1) according to one of the claims 5 to 7, characterized in that the means (17, 18) for an opening of the pack compartments (28a, 28b) are designed for a substantially simultaneous opening of at least two pack compartments (28a, 28b).

9. Adapter (1) according to one of the preceding claims, characterized in that the adapter (1) comprises connecting means (7) for a connecting to subsequent means, specifically mixers (21) and/or nozzles (22), and specifically that these connecting means (7) comprise screw connections.

10. Adapter (1) according to one of the preceding claims, characterized in that it is designed for a leading together of at least two commodities extracted from the pack compartments (28a, 28b) in the area of the outlet of the adapter (1), and specifically that it comprises in this area a mixing zone.

11. Adapter (1) according to one of the preceding claims, characterized in that the adapter (1) is produced of a plastic material, specifically of a plastic material with a small adhesive force relative to multicomponent adhesive agents, and specifically in that it is produced by a injection molding.

12. Apparatus for extracting commodities from multicompartment sausage packs (10), comprising an adapter (1) according to one of the preceding claims and at least one means for leading the commodities extracted from the pack compartments (28a, 28b) together, specifically comprising an adapter (1) according to one of the preceding claims and a static mixer (21).

13. Apparatus according to claim 12, comprising further a pressing out apparatus (23) for a multicompartment sausage pack (10).

14. Sausage pack packaging comprising an adapter (1) or an apparatus according to one of the claims 1 to 13 and a multicompartment sausage pack, specifically a double compartment sausage pack (10).

15. Sausage pack packaging according to claim 14, characterized in that the through flow channels (11a, 11b) in the adapter (1) communicate in the not opened state of the sausage pack packaging with the pack compartments (28a, 28b).

16. Sausage pack packaging according to claim 15, characterized in that the discharge openings (16a, 16b) of the through flow channels (11a, 11b) of the adapter (1) are closed off by at least one closing means.

17. Sausage pack packaging according to claim 16, characterized in that the closing means are recloseable, specifically that they comprise screw caps, and specifically that the recloseable closing means are undetachably mounted to the adapter (1).

18. Sausage pack packaging according to one of the claims 16 or 17, characterized in that the closing means comprise removable or destroyable foils, specifically peel-off metal foils.

19. Application of the adapter (1) according to one of the claims 1 to 11 for a filling of multicompartment sausage packs, specifically double compartment sausage packs (10).

20. Method of extracting commodities from multicompartment sausage packs, specifically extracting commodities from double compartment sausage packs (10), wherein the commodities extracted from the pack compartments (28a, 28b) are led substantially separate in an adapter (1), characterized in that the commodities extracted from the pack compartments (28a, 28b) of the multicompartment sausage pack (10) are led through at least two through flow channels (11a, 11b) in the adapter (1), whereby these commodities are brought into a direct contact with the inner walls of the through flow channels (11a, 11b).

21. Method according to claim 20, characterized in that the commodities extracted from the pack compartments (28a, 28b) of the multicompartment sausage pack (10) are guided in a substantially axial direction and are brought to be discharged in axial direction.

22. Method according to one of the claims 20 to 21, wherein the sausage pack (10) comprises an axis and the commodities extracted from the pack compartments (28a, 28b) are led through the through flow channels (11a, 11b) to discharge openings (16a, 16b) arranged at the side of the adapter (1) which in axial direction is facing away from the sausage pack (10).

23. Method according to claim 22, wherein the commodities extracted from the pack compartments (28a, 28b) are led through the through flow channels (11a, 22b) to discharge openings (16a, 16b) which are located in a central area of the adapter (1).

24. Method according to one of the claims 20 to 23, characterized in that the sausage pack compartments (28a, 28b) are opened by means (17, 18) for opening of same which are located at the adapter (1).

25. Method according to claim 24, characterized in that an opening of the pack compartments (28a, 28b) of the sausage pack (10) is caused by a pressure action onto the sausage pack or by an axial pressing of the adapter (1) onto the sausage pack (10).

26. Method according to claim 24, characterized in that an opening of the pack compartments (28a, 28b) is performed by a piercing of the outer skin of the sausage pack (10) by opening means (18) from the outside.

27. Method according to one of the claims 24 to 26, characterized in that the opening of at least two pack compartments (28a, 28b) occurs substantially simultaneously.

28. Method according to one of the claims 20 to 27, wherein subsequent means, specifically mixers (21) and/or nozzles (22) are mounted to the adapter (1), and specifically that these are screwed onto the adapter (1).

29. Method according to one of the claims 20 to 28, wherein at least two of the commodities extracted from the pack compartments (28a, 28b) are led together in the adapter (1) in the area of its exit, and specifically wherein these commodities are mixed in this area.
